(19) United States
(12) Patent Application Publication
(10) Pub. No.: US 2012/0318384 A1
(43) Pub. Date: Dec. 20, 2012

(54) VALVE FOR CONTROLLING A FLOW CHANNEL

(76) Inventor: Jürgen Sohn, Esslingen (DE)

(21) Appl. No.: 13/580,987

(22) PCT Filed: Feb. 18, 2011
(86) PCT No.: PCT/EP2011/052434

§ 371 Date: Aug. 24, 2012

(30) Foreign Application Priority Data
Feb. 24, 2010 (DE) 102010009173.1

(51) Int. Cl. F16K 17/38

(52) U.S. Cl. 137/468

(57) ABSTRACT

The invention relates to a valve for actuating a flow channel (12), having a valve housing (16) disposed in the flow channel (12) with a throttle body (28) for forming a throttle point (14), and having a bypass valve (11) disposed in the flow channel (12) that can be actuated dependent on the temperature of the fluid, forming a bypass passage (30) together with at least one bypass opening (32), wherein a continuous change in the cross section of the bypass passage (30) of the bypass valve (31) can be actuated dependent on the temperature-based changes in viscosity of the fluid.

The invention relates to a valve for controlling a flow channel, said valve being arranged in the flow channel with a throttle body so as to form a throttle point.

For example, a variable throttle valve is known from DE 10 2005 021 975 A1 and is used for a hydraulic actuation device. This valve comprises a housing, through which a fluid channel extends. A valve element formed as a thermo bimetal snap disc is arranged within the fluid channel and, as the temperature changes, independently changes shape or position so as to influence the cross-section of the fluid channel. When a predefined snap temperature is exceeded, this thermo bimetal snap disc springs into a different shape, wherein it can thus close a variable channel and therefore changes the cross-section of the entire flow. As soon as the temperature falls below a specific snap temperature, the snap disc springs back into the starting shape. Actuation for changing the cross-section is therefore only provided at a specific snap temperature.

Furthermore, valves are known, in particular throttle valves, which are often used for example for door closers, often even outdoors. The hydraulic door closers have a piston arranged in a closer housing, said piston being loaded by a sprung and cooperating with a shaft on which a lever for actuating a door is arranged. When the door is opened, the lever is actuated and the spring resting against the piston is tensioned via the shaft and the piston. The hydraulic fluid situated in the closer housing can flow via hydraulic channel and valves from one piston side to the other, since the piston chambers on either side of the piston change as a result of the displacement of said piston. When the door is opened, the hydraulic fluid can thus flow in the easiest possible manner so that the door is actuated in an unbraked manner. When the door is closed independently, the piston is guided back into its starting position due to the relief of the spring, which is tensioned during the opening process, wherein the hydraulic fluid again has to flow to the other piston side or back. Due to the arrangement of hydraulic channels with valves, the closing process can be carried out in a braked manner, wherein a number of phases of the closing process are possible at different closing speeds, thus allowing the door to be closed safely.

Such door closers operate by the principle of positive displacement. Due to the temperature-dependent viscosity of the fluid, in particular of the hydraulic fluid, regular adjustment of the valves is necessary due to weather, particularly in the case of external doors, so as to achieve constant conditions and so as to ensure the desired closing behaviour. The same applies to other fields of application, in which different working conditions of devices, objects and the like are set at a throttle point due to the temperature-dependent change in viscosity of the fluid.

The object of the invention is therefore to create a valve which detects the temperature changes and independently balances the temperature-induced changes in viscosity of the hydraulic fluid.

This object is achieved in accordance with the invention by the features of claim 1. Further advantageous embodiments and developments are disclosed in the further independent claims.

As a result of the valve according to the invention for controlling a flow channel, it is possible to set a constant cross-section of flow by a basic adjustment of a throttle body of the valve relative to the flow channel, and also to actuate a continuous change of the cross-section of the bypass passage of the bypass valve, in addition to the cross-section of the throttle point, according to the temperature-induced change in viscosity of the fluid. It is thus possible, using the actuatable bypass valve, to increase the cross-section of the opening of the throttle point in the flow channel when ambient or external temperature fails and the viscosity of the fluid thus increases so as to balance the increase in viscosity so that an increased mass flow rate of the fluid can flow through the throttle point and the set period for actuation of a movement by the fluid can be maintained compared to a viscosity deviating therefrom. For example, if the ambient or external temperature rises, the viscosity of the fluid falls in turn, and therefore there would be an increased mass flow rate. Due to the directly temperature-dependent actuation of the bypass valve, which closes in part or completely, the target time for the adjustment process can in turn be set and maintained by reducing the throttle cross-section. The temperature of the fluid is thus the control variable for the changeable cross-section of flow of the bypass passage of the bypass valve and makes it possible to change continuously the throttle cross-section of the bypass valve according to the temperature of the fluid. Due to the integration of the bypass valve, which can be actuated in a temperature-dependent manner, into the valve, the design of the previous throttle point can be retained in essence, and therefore valves can be provided which can be replaced easily by exchanging the previous valves, which have disadvantageous properties in terms of actuation of the mass flow rate.

In accordance with a preferred embodiment of the invention, the bypass valve has a valve element, which opens and closes at least one bypass opening and controls the bypass passage, and the bypass passage preferably increases the cross-section of the throttle point and in particular is assigned to the throttle body, which preferably forms a constant throttle cross-section relative to the flow channel. A structurally simple design of the valve is thus created, whereby the constant throttle point formed by the arrangement of the throttle body relative to the flow channel can be increased when the viscosity of the fluid changes due to temperature.

Alternatively, the bypass valve has a valve element, which opens or closes at least one bypass opening at the outer periphery of the throttle body and controls a bypass passage passing through the throttle body. The cross-section of flow of the throttle point can thus be increased according to temperature so as to compensate for the increase in viscosity when ambient temperatures fall.

Furthermore, the bypass valve is preferably arranged in a valve housing and the at least one bypass opening connects an outer face of the valve housing to a chamber arranged in the valve housing. The chamber arranged in the valve housing enables full integration and accommodation of a bypass valve. At the same time, a simple design and a closed arrangement are made possible due to a simple exchange of such a valve.

The valve element is preferably guided displaceably in the chamber in the valve housing so that it closes the at least one bypass opening in a closed position. The valve element is preferably formed as a slide so that the at least one bypass opening arranged in a wall of the valve housing can be closed, opened merely in part, or opened completely by a simple displacement of the valve element, and the cross-section of flow can be adjusted according to temperature. To this end, the slide preferably has an outer peripheral portion supported against the chamber wall so that the valve element can be guided and the bypass opening can be closed by this peripheral portion. Alternatively, these two functions can also be formed separately on the slide.

Furthermore, the throttle body is preferably provided as a wall portion at the outer periphery of the valve housing, in particular as a fixed housing contour. For example, the at least one bypass opening of the bypass valve discharges into the outer peripheral face of the throttle body or adjoins it or is operatively connected to the throttle body. The positioning and arrangement may be manifold, wherein the cooperation between the bypass valve and the throttle body is such that the entire throttle cross-section in the flow channel can be changed when viscosity changes due to temperature.

The valve element of the bypass valve is preferably formed as a cylindrical hollow body, an energy storage element engaging with one end face thereof and a thermal actuator engaging with the other end face thereof. The thermal actuator is preferably also formed as an energy storage element. Due to the arrangement of energy storage elements on either side, the valve element is guided displaceably in the chamber. The valve element may preferably be formed as a rotationally symmetrical component, wherein the outer periphery thereof simultaneously constitutes the guide surfaces of the valve element in an inner wall of the valve housing. A central through-hole is preferably provided in the valve element, and therefore the fluid flowing into the valve housing can disperse completely in the chamber. Due to this arrangement, a floating valve element is created, which can be converted into an open and/or closed position depending on the energy storage elements. The temperature of the fluid affects the actuation force of the thermal actuator, both when the bypass valve is closed and when the bypass valve is open. If the bypass valves are closed, this is preferably enabled by the fact that fluid flows externally over the chamber in which the thermal actuator is positioned.

The bypass valve, which can be actuated in a temperature-dependent manner, preferably has a return spring element as an energy storage element, said return spring element being disposed between a base of the chamber and the valve element and having the thermal actuator as a control device, said thermal actuator preferably being formed as an energy storage element made of a shape-memory alloy and being disposed between the ceiling of the chamber and the valve element and acting in the closing direction when the temperature changes. For example, when the external temperature rises, the closing force of the thermal actuator can be greater than that of the return spring element so that the bypass openings are closed by the valve element. For example, at an ambient temperature of 20° C. and with use of the valve in a door closer, the thermal actuator and the return spring element are selected in such a way that the bypass valve is arranged in a closed position. As soon as the temperature decreases and, for example, falls to 0° C. or to −10° C., the thermal actuator draws together increasingly. At the same time, the return spring element displaces the valve element in the opening direction so that the bypass openings are increasingly released. As viscosity rises, the same mass flow rate as with an external temperature of 20° C. for example can be achieved, wherein the size and/or number of the bypass openings are adapted thereto.

In accordance with a further preferred embodiment of the invention, the end face or end faces of the valve element on the return spring side and the end face of the valve element facing the thermal actuator are formed as pressure surfaces of equal size. The forces of the fluid pressure acting on the valve element can thus be balanced in the chamber as soon as the bypass openings are at least partially opened, and the fluid can flow into the chamber. Due to the fact that the pressure surfaces are of equal size, the lifting movement of the valve element is actuated exclusively by the thermal actuator and the return spring element, since the pressures acting on the valve element or on the pressure surface thereof are cancelled out reciprocally.

To adjust the bias of the thermal actuator for actuating the lifting movement or the opening and closing movement and for controlling the moment at which the valve element is opened and closed by the bypass valve, the base of the chamber and/or the ceiling of the chamber in the valve housing is/are preferably adjustable so as to adjust the height of the chamber.

In accordance with a further preferred embodiment of the valve, a one-part valve housing is provided, which has the throttle body at the outer periphery and comprises at least one bypass opening discharging into the chamber as well as a holder, in particular a tool holder, having a fastening portion so as to adjust the throttle body of the valve housing relative to the flow channel. In a one-part valve housing of this type, the valve element of the bypass valve can be introduced into the chamber of the valve housing, as is an adjustment element forming a ceiling of the chamber. In this embodiment, the number of components for producing the valve is reduced to a minimum. At the same time, assembly is simple, since the return spring element, the valve element and the thermal actuator are first introduced and screwed into the chamber of the valve housing, followed by the adjustment element to adjust and position these parts in the chamber. The entire valve housing can then be introduced into the flow channel to be reduced.

In accordance with an alternative embodiment of the valve, the valve housing is formed in two parts and has a first, preferably sleeve-shaped, housing part, with the chamber for receiving the bypass valve, the throttle body and the at least one bypass opening discharging into the chamber, and comprises a second housing part, which has a tool holder having a fastening portion for adjustment of the valve housing relative to the throttle point, wherein the first and second housing part are interconnected releasably in such a way that the height of the chamber can be varied, or are interconnected non-releasably and in a height-adjustable manner. This two-part embodiment has the advantage that standardised components can be used for example for the housing part having the tool holder and the fastening portion, and first housing parts of different design can be arranged depending on the throttle point and the required cross-section of flow relative to the flow channel. In these first housing parts, both the design of the throttle body and/or the size of the chamber and/or of the bypass openings may differ from one another. For example, the first and second housing part can preferably be interconnected adjustably via a screw thread so that the height of the chamber and the at least one bias of the thermal actuator can also be adjusted. Alternatively, a latched, press-fit or bonded connection can position the two housing parts relative to one another, thus enabling easy assembly. In addition, the height of the chamber can also be adjusted.

In accordance with a further alternative embodiment of the valve, the valve housing is formed in two parts, and a first housing part comprises a chamber base and a throttle body whilst the second housing part has a valve housing comprising a chamber for receiving the valve element for the bypass valve as well as a tool holder comprising a fastening portion, and the first and second housing part can be varied or adjusted in height by a releasable connection or can be interconnected non-releasably. Compared to the two-part embodiment of the valve housing described above, in this embodiment the separation point is situated close to the base of the chamber. In this alternative embodiment, the same advantages as in the previous embodiment can also be achieved.

In a preferred embodiment, the valve housing, the tool holder comprising the fastening portion, and the valve element are produced from plastics material. A valve of this type can thus be produced in a cost effective manner.

Furthermore, the valve housing, the throttle body and the bypass valve are preferably formed as a cartridge. This cartridge may be formed in one part, two parts, or in a number of parts. Due to the embodiment as a cartridge, the valve can be easily stored, transported, and installed and removed as a single component, and can thus also be retrofit or can replace valves already in use in a simple manner.

Furthermore, the valve housing of the valve preferably has the outer dimensions of a valve for a hydraulic door closer. This valve can thus be used easily for existing throttle valves, and the advantage of the thermally actuatable bypass valve can be utilised.

The invention and advantageous embodiments and developments thereof will be described and explained in greater detail hereinafter with reference to the examples illustrated in the drawings. In accordance with the invention, the features to be inferred from the description and the drawings can be applied individually or together in any combination. In the drawings:

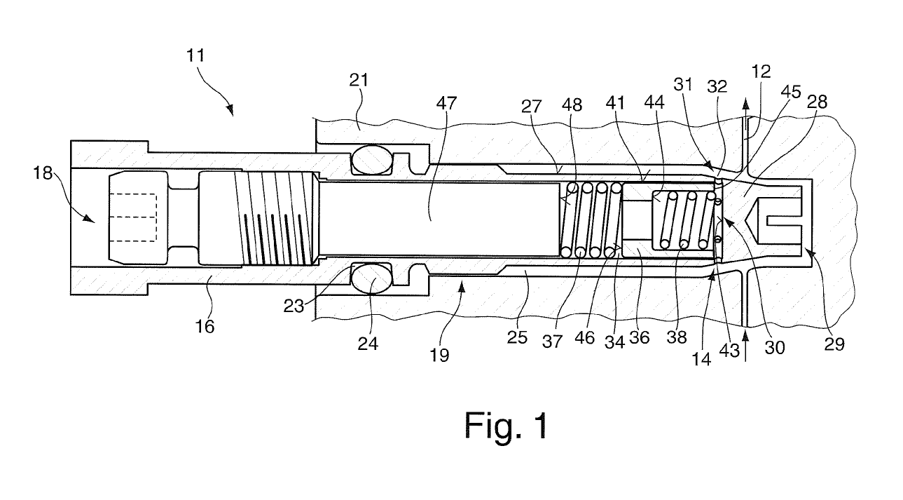

FIG. 1 shows a schematic sectional view of a first embodiment of the valve according to the invention;

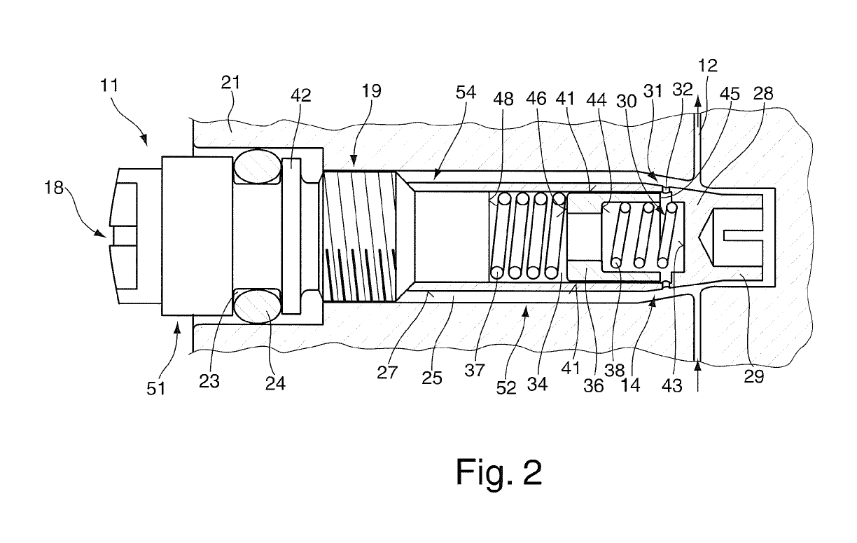

FIG. 2 shows a schematic view of an alternative embodiment to FIG. 1; and

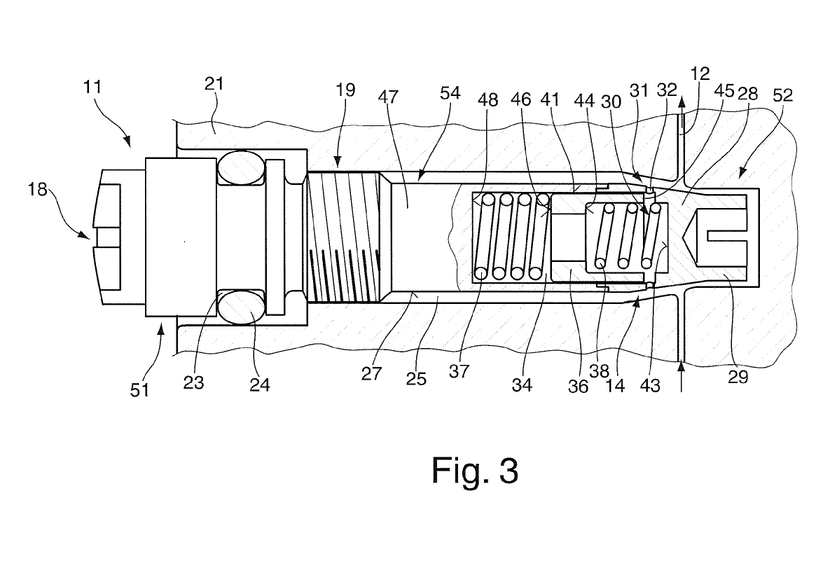

FIG. 3 shows a schematic view of a further alternative embodiment to FIG. 2.

FIG. 1 illustrates a schematic sectional view of a valve 11, which is introduced into a flow channel 12 and through which a fluid flows. For example, this arrangement can be provided in a door closer operating with hydraulic fluid, wherein the flow channel 12 is arranged in a closer housing and, when the door is closed, a hydraulic fluid flows from one piston chamber into a second piston chamber and the door is closed in a damped manner due to a throttle point 14 between the valve 11 and the flow channel 12. The damped closure can be adjusted by the throttle point 14 according to the position of said throttle point relative to the flow channel 12. The use of the valve 11 for a door closer is merely exemplary and can also be implemented for analogous control of further devices, apparatuses or objects by means of a fluid.

The valve 11 comprises a valve housing 16, which has a tool holder 18 comprising a fastening portion 19. For example, the valve 11 can be screwed in and unscrewed via the tool holder 18. The fastening portion 19 engages with a housing 21, through which the flow channel 12 passes. For example, an annular groove 23 is provided between the tool holder 18 and the fastening portion 19 and is used to receive a seal 24 so as to seal a receiving chamber 25 of the housing 21, into which part of the valve housing 16 is inserted, with respect to the surrounding environment.

The valve housing 16 also has a cylindrical wall portion 27, to which a throttle body 28 is attached. For example, this throttle body 28 is conical and is arranged or moulded on the outer periphery of the valve housing 16. An end portion 29 is arranged at the outer end of the valve housing 16. The throttle point 14 is formed by the free cross-section of flow, which is produced from the contour of the receiving chamber 25 and the introduced valve housing 16, in particular the throttle body 28, which is associated with the inlet and outlet openings of the flow channel 12 into and out from the receiving chamber 25. Due to the throttle body 28, the cross-section of flow of the flow channel 12 can be adjusted by a change to the position in the receiving chamber 25. For example, the cross-section of flow can be increased or reduced by a screwing or unscrewing motion. The throttle body 28 is also formed in such a way that the inlet and outlet opening of the flow channel 12 is closed when the valve is screwed fully into the receiving chamber 25. For example, the door can thus be fixed in a specific position, for example so as to carry out decoration or installation work.

A bypass valve 31 is preferably arranged in the valve housing 16 in the region of the throttle body 28. This bypass valve 31 comprises at least one bypass opening 32, which extends from an outer face of the throttle body 28 into a chamber 34 in the valve housing 16 and is connected to a further bypass opening 32 and forms a bypass passage 30. The bypass openings 32 are preferably formed as bores or elongate openings and, in particular, are distributed uniformly over the periphery. All openings are preferably arranged in a common axial plane of the chamber. Alternatively, they can also be arranged along a pitch of a thread so that a bypass opening is additionally opened little by little. A valve element 36 is arranged in the chamber 34 and can be transferred by a thermal actuator 37 made of a shape-memory alloy into a closed position and can be transferred by a return spring element 38 formed as an energy storage element into an open position. For example, the valve element 36 is formed as a hollow cylindrical body and has an outer peripheral surface 41, which is used as a guide surface in the chamber 34 of the valve housing 16. At the same time, this outer peripheral surface 41 allows the bypass openings 32 to be closed in a closed position so that an additional opening cross-section is not available. The return spring element 38 is supported against a base 43 of the chamber, which can also be stepped to hold the return spring element 38 securely, and contacts an annular shoulder 44 of the valve element 36. The chamber 34 of the valve housing 16 is closed opposite the base 43 of the chamber by a ceiling 48 of the chamber. The thermal actuator 37 is arranged between the valve element 36 and the ceiling 48 of the chamber. The thermal actuator 37 is supported against an end face 45 of the valve element 36.

In a closed position of the valve element 36, an end face 46 of said valve element contacts the base 43 of the chamber. At the same time, the at least one bypass opening 32 discharging into the chamber 34 is closed.

The end face 46 and the annular shoulder 44 of the valve element 36 form a pressure surface when the chamber 34 is pressurised by fluid, said pressure surface preferably being the same size as the pressure surface formed by the end face 45, against which the thermal actuator 37 rests. The pressure of the fluid present in the chamber 34 thus acts neutrally on the valve element, and therefore the displacement of said valve element is determined exclusively by the thermal actuator 47 and by the return spring element 38.

In the embodiment according to FIG. 1, the ceiling 48 of the chamber is formed by an end face of an adjustment element 47 which can be inserted into the valve housing 16.

The adjustment element 47 is adjustable relative to the valve housing 16 so that the height of the chamber 34 is determined by the adjustment element. A basic adjustment or a moment of opening and closing of the thermal actuator 37 can thus be set.

In particular when used as a door closer, such a valve 11 makes it possible to compensate for the temperature-induced change in viscosity of the hydraulic fluid and allows the closing time of the door to be kept practically constant, irrespective of the ambient or external temperatures. For example, a basic adjustment of the closing time for a door closer at ambient temperature is implemented as a result of a corresponding positioning of the valve 11 with its throttle body 23 in the flow channel 12 so as to form the throttle point 14. Once this basic adjustment has been implemented, a constant opening cross-section for the flow channel 12 is released, which determines a predetermined closing time due to the viscosity of the fluid at the temperature at the time of the adjustment, or allows a predetermined flow rate of fluid, in particular hydraulic fluid, within a specific interval. At ambient temperature, the bypass valve 31 is closed for example, that is to say the thermal actuator 37 made of a shape-memory alloy is arranged relative to the return spring 38 in such a way that relatively high forces of the actuator act as restoring forces of the return element 38.

As soon as the ambient or external temperature falls, the resilience of the thermal actuator 37 decreases and is lower than the resilience of the return spring element 38, that is to say the valve element 36 releases the bypass openings 32, at least in part. The throttle point 14 can thus be increased with respect to the overall opening cross-section thereof. This allows an increased mass flow rate of the hydraulic fluid, wherein it should be considered, however, that the viscosity is in turn increased as a result of the falling ambient and external temperature and an increasing closure time is thus compensated for by the increase in the cross-section of flow. The cross-section of the bypass valve 31 can thus be changed continuously in a manner directly dependent on the temperature of the fluid.

FIG. 2 illustrates an alternative embodiment of the valve 11 according to FIG. 1. The basic design, function and operating principle of the valve 11 according to FIG. 1 are also provided in the valve 11 according to FIG. 2. Merely the structural design of the valve housing 16 differs from the embodiment in FIG. 1. In this embodiment in FIG. 2, a two-part valve housing 16 is provided. A first housing part 51 comprises the tool holder 18 and the fastening portion 19 as well as the groove 23 for receiving a seal 24. Furthermore, the ceiling 48 of the chamber is arranged on the housing part 51. The second housing part 52 comprises a valve housing 16 for forming the chamber 34, the throttle body 28 and the bypass openings 32 and the end portion 29.

In this embodiment, the first and second housing part 51, 52 can be interconnected, in particular screwed together, at a connection portion 54, so as to adjust the height of the chamber 34. Alternatively, the two housing parts 51 and 52 can be interconnected non-releasably at the connection portion 54, for example by press-fitting, adhesive bonding, welding or the like. The height of the chamber can likewise be adjusted beforehand.

FIG. 3 illustrates an alternative embodiment of the valve 11 to FIG. 2. The two-part embodiment of the valve housing 16 is maintained in principle by a first and second housing part 51, 52, wherein the connection portion 54 between the first and second housing part 51, 52 lies in the region of the chamber 34 in this embodiment, and therefore part of the wall of the chamber 34 is connected integrally to the first housing part 51, and part of the wall of the chamber 34 is connected to the housing part 52. The connection portion 54 can be formed similarly to the embodiment according to FIG. 2. A catch, bayonet closure or the like may also be provided.

1. Valve for controlling a flow channel, said valve having a valve housing arranged in the flow channel with a throttle body for forming a throttle point, and having a bypass valve arranged in the flow channel, actuatable according to the temperature of the fluid and forming a bypass passage having at least one bypass opening, wherein a continuous change in the cross-section of the bypass passage of the bypass valve is actuatable according to the temperature-induced changes in viscosity of the fluid.

2. Valve according to claim 1, wherein the bypass valve has a valve element, which opens or closes the at least one bypass opening and controls the bypass passage.

3. Valve according to claim 1, wherein the bypass valve has a valve element, which releases or closes the at least one bypass opening at the outer periphery of the throttle body and actuates a bypass passage passing through the throttle body.

4. Valve according to claim 1, wherein the bypass valve is arranged in a valve housing and the at least one bypass opening connects an outer face of the valve housing to a chamber arranged in the valve housing.

5. Valve according to claim 1, wherein the throttle body is provided as a wall portion at the outer periphery of a valve housing, in which the bypass valve is preferably arranged and the at least one bypass opening is provided in the region of the throttle body or adjacent thereto or close thereto.

6. Valve according to claim 2, wherein the valve element is formed as a cylindrical hollow body, an energy storage element engaging with one end face thereof and a thermal actuator engaging with the other end face thereof.

7. Valve according to claim 6, wherein a return spring element is arranged as an energy storage element between a base of the chamber and the valve element, and the thermal actuator acting in the closing direction is arranged between a ceiling of the chamber and the valve element.

8. Valve according to claim 6, wherein an end face or end faces of the valve element on the return spring side and an end face of the valve element facing the thermal actuator are formed as pressure surfaces of equal size.

9. Valve according to claim 1, wherein the position of a base of the chamber or of a ceiling of the chamber is variable in relation to the valve housing and the bias of the thermal actuator is adjustable.

10. Valve according to claim 1, wherein the valve housing is formed in one part, which has the throttle body at the outer periphery and in that tine valve element is introducable into the chamber of the valve housing, said valve element closing at least the bypass opening discharging into the chamber, and in that an adjustment element for regulating the moment at which the bypass valve is opened is introducable into the valve housing.

11. Valve according to claim 1, wherein the valve housing is formed in two parts and has a first housing part, with the chamber for receiving the valve element, the throttle body and the at least one bypass opening discharging into the chamber, and comprises a second housing part, with a tool holder for adjustment of the valve housing and the throttle body thereof relative to the flow channel, the first and second housing part preferably being interconnected by a releasable connection, a latched connection or non-releasably, in such a way that the height of the chamber is adjustable.

12. Valve according to claim 1, wherein the valve housing is formed in two parts, and a first housing part comprises a chamber base and a throttle body whilst the second housing part has a chamber for receiving the valve element for the bypass valve as well as a tool holder, the first and second housing part being interconnected by a releasable connection, a latched connection or being non-releasably interconnected.

13. Valve according to claim 1, wherein the valve housing, the tool holder, and the fastening portion, as well as the valve element are produced from plastics material.

14. Valve according to claim 1, wherein the valve housing of the throttle body and the bypass valve are formed as cartridges.

15. Valve according to claim 1, wherein the valve housing has the outer dimensions of a valve for a hydraulic door closer.

16. Valve according to claim 1, wherein the bypass passage increases the cross-section of the throttle point in the flow channel.

17. Valve according to claim 1, wherein the bypass passage is assigned to the throttle body, which forms a constant throttle cross-section relative to the flow channel.

18. Valve according to claim 6, wherein the valve element is guided displaceably in the chamber as a slide, and an outer peripheral portion of the valve element supported against the chamber wall closes the at least one bypass opening.

19. Valve according to claim 1, wherein the thermal actuator is formed from a shape-memory alloy.

20. Valve according to claim 14, wherein the valve housing comprises a tool holder, for adjustment of the throttle body of the valve housing relative to the flow channel.
